(19) United States
(12) Patent Application Publication
(10) Pub. No.: US 2024/0153663 A1
(43) Pub. Date: May 9, 2024

(54) RADIONUCLIDE PRODUCTION SYSTEM AND RADIONUCLIDE PRODUCTION METHOD

(71) Applicant: HITACHI, LTD., Tokyo (JP)

(72) Inventors: Takahiro TADOKORO, Tokyo (JP); Yuichiro UENO, Tokyo (JP); Yuuko KANI, Tokyo (JP); Kento NISHIDA, Tokyo (JP); Takahiro WATANABE, Tokyo (JP); Takahiro SASAKI, Tokyo (JP); Masaharu ITO, Tokyo (JP)

(21) Appl. No.: 18/280,279

(22) PCT Filed: Mar. 17, 2022
(86) PCT No.: PCT/JP2022/012455

§ 371 Date: Sep. 5, 2023

(30) Foreign Application Priority Data
Apr. 27, 2021 (JP) 2021-074871

(51) Int. Cl. G21G 1/12

(52) U.S. Cl. CPC G21G 1/12

(57) ABSTRACT

A radionuclide production system is a system for producing a radionuclide by irradiating a liquid containing a raw material nuclide with bremsstrahlung radiation, the radionuclide production system including: a circulation path configured to allow a liquid containing a raw material nuclide to circulate; and a radiation generation unit configured to generate bremsstrahlung radiation to irradiate the liquid. A metal member containing a pure metal of a platinum group or an alloy of the platinum group is provided at an upper portion in the circulation path. In a radionuclide production method, the raw material nuclide contained in the liquid is transformed to the radionuclide by irradiating the liquid with the bremsstrahlung radiation while circulating the liquid containing the raw material nuclide in the circulation path, and oxygen and hydrogen generated due to radiolysis of the liquid are removed by a recombination reaction with a metal member formed of the pure metal.

### TECHNICAL FIELD

The present invention relates to a radionuclide production system and a radionuclide production method of producing a radionuclide by utilizing a nuclear reaction caused by bremsstrahlung radiation.

Actinium 225 (Ac-225) is a radionuclide that emits alpha rays, and is expected to be used as a raw material of a therapeutic drug used in alpha-ray therapy. In a related art, actinium 225 (Ac-225) is produced by decay from thorium 229 (Th-229) that is a parent nuclide.

Currently, there are only three facilities capable of supplying clinically available Ac-225: the Institute for Transuranium Elements (ITU) in Karlsruhe, German, the Oak Ridge National Laboratory (ORNL) in United States, and the Institute of Physics and Power Engineering (IPPE) in Obninsk, Russia.

Th-229 is not found in the natural world, but is generated by decay from the urination 233 (U-233). However, since U-233 is not produced in the future in relation to protection of nuclear substances, a production capacity of Ac-225 in the entire world is limited to a range within which the production is possible from the existing U-233 through Th-229. This capacity is sufficient for preclinical testing, but is expected to be significantly insufficient after clinical testing. Therefore, production using an accelerator is desired.

As a method of producing Ac-225 using an accelerator, a method using the reaction Ra-226(p,2n)Ac-225 is known. In this method, radium 226 (Ra-226) existing naturally is irradiated with protons accelerated by a cyclotron. Production testing is advanced in ORNL, the Brookhaven National Laboratory (BNL) in United States, and the National Institutes for Quantum and Radiological Science and Technology (QST) in Japan, but is not commercialized.

The method of producing Ac-225 using an accelerator has a problem in production. Since a range of the proton accelerated by the cyclotron in Ra-226 is short, a problem occurs that Ac-225 cannot be produced in a large amount even if the target is thickened. Most of proton energy is lost in the target, but it is difficult to sufficiently remove heat from the target. Therefore, it is difficult to make the proton energy higher than that in the related art.

As the method of producing Ac-225 using an accelerator, a method of performing β-decay on Ra-225 to transform Ra-225 to Ac-225 after the reaction Ra-226(n,2n)Ra-225 is also known. In this method, Ra-226 is irradiated with high-speed neutrons. However, when the irradiation is performed with neutrons, a problem occurs that a size of a device is increased for shielding, and a problem occurs that radioactive waste is increased due to radioactivation of the device.

In addition, a method of performing β-decay on Ra-225 to transform Ra-225 to Ac-225 after the reaction Ra-226(γ,n)Ra-225 is proposed. In this method, Ra-226 is irradiated with bremsstrahlung radiation. The bremsstrahlung radiation is generated by irradiating a target member having a large atomic number with electrons accelerated by a microtron, a linear accelerator, or the like. PTL 1 describes a technique of producing a radionuclide by irradiating a fluid containing a raw material nuclide in a circulation path with bremsstrahlung radiation while circulating the fluid in the circulation path.

### CITATION LIST

### Patent Literature

PTL 1: JP2020-183926A

### SUMMARY OF INVENTION

### Technical Problem

As in PTL 1, when irradiating the liquid containing the raw material nuclide with the radiation while circulating the fluid in the circulation path, the target radionuclide can be produced in the fluid without using a solid target member. Since the target member is not melted by irradiation, it is not necessary to intermittently irradiate the radiation at long time intervals. In addition, in order to obtain the target radionuclide generated in the target member, an operation of taking out the target member is not necessary. Therefore, the target radionuclide can be efficiently produced.

However, when the fluid containing the raw material nuclide is irradiated with the radiation, not only the raw material nuclide is nuclear transformed, but also a medium in the fluid may be subjected to radiolysis. For example, if the reaction Ra-226(γ,n)Ra-225 is used, an acid solution obtained by dissolving a chloride, an oxide, or the like containing Ra-226 in acid is used. The acid solution contains water. Therefore, at least a part of the water is subjected to radiolysis to generate an oxygen gas and a hydrogen gas.

As in PTL 1, in the case where the fluid containing the raw material nuclide is circulated in the circulation path, when a gas is generated by the irradiation performed with the radiation, a problem occurs that the gas accumulates in the circulation path. When the gas accumulates, a pressure increases, and fluid leakage, pipe rupture, or the like may occur. Therefore, diffusion of a radioactive substance and exposure of a manufacturer pose safety problems. In addition, since the oxygen gas and the hydrogen gas may fall within a range of an explosion limit, a risk of explosion occurs.

It is considered that the gas generated in the circulation path is discharged to the outside at a stage when a predetermined pressure is reached. However, when such a measure is taken, it is necessary to provide a gas discharge opening in the circulation path and remove the radioactive substance in the gas to be discharged. It is necessary to provide a radioactive gas treatment device in the gas discharge opening, but providing the radioactive gas treatment device causes an increase in size and weight of the entire system.

Therefore, an object of the invention is to provide a radionuclide production system and a radionuclide production method capable of efficiently producing a radionuclide by a small, lightweight, and highly safe device.

### Solution to Problem

In order to solve the above problem, a radionuclide production system according to the invention is a radionuclide production system for producing a radionuclide by irradiating a liquid containing a raw material nuclide with bremsstrahlung radiation, the radionuclide production system including: a circulation path configured to allow a liquid containing a raw material nuclide to circulate; and a radiation generation unit configured to generate bremsstrahlung radiation to irradiate the liquid. A metal member containing a pure metal of a platinum group or an alloy of the platinum group is provided at an upper portion in the circulation path.

In addition, a radionuclide production method according to the invention is a radionuclide production method of producing a radionuclide by irradiating a liquid containing a raw material nuclide with bremsstrahlung radiation, the radionuclide production method including: transforming a raw material nuclide contained in a liquid to a radionuclide by irradiating the liquid containing the raw material nuclide with bremsstrahlung radiation while circulating the liquid in a circulation path; and removing oxygen and hydrogen generated due to radiolysis of the liquid by a recombination reaction with a metal member formed of a pure metal of a platinum group or an alloy of the platinum group at an upper portion in the circulation path.

### Advantageous Effects of Invention

The invention can provide a radionuclide production system and a radionuclide production method capable of efficiently producing a radionuclide by a small, lightweight, and highly safe device.

### BRIEF DESCRIPTION OF DRAWINGS

FIG. 1 is a schematic diagram showing an example of a radionuclide production system according to the invention.

FIG. 2 is a graph showing theoretical values of a reaction cross-section of (γ,n) reaction of Ra-226.

FIG. 3 is a schematic diagram showing an example of a radionuclide production system according to the invention.

FIG. 4 is a schematic diagram showing an example of a radionuclide production system according to the invention.

FIG. 5 is a schematic diagram showing an example of a radionuclide production system according to the invention.

FIG. 6 is a schematic diagram showing an example of a radionuclide production system according to the invention.

FIG. 7 is a schematic diagram showing an example of a radionuclide production system according to the invention.

FIG. 8 is a schematic diagram showing an example of a radionuclide production system according to the invention.

### DESCRIPTION OF EMBODIMENTS

Hereafter, a radionuclide production system and a radionuclide production method according to an embodiment of the invention will be described with reference to the drawings. In the following drawings, common components are denoted by the same reference numerals, and repetitive descriptions thereof are omitted.

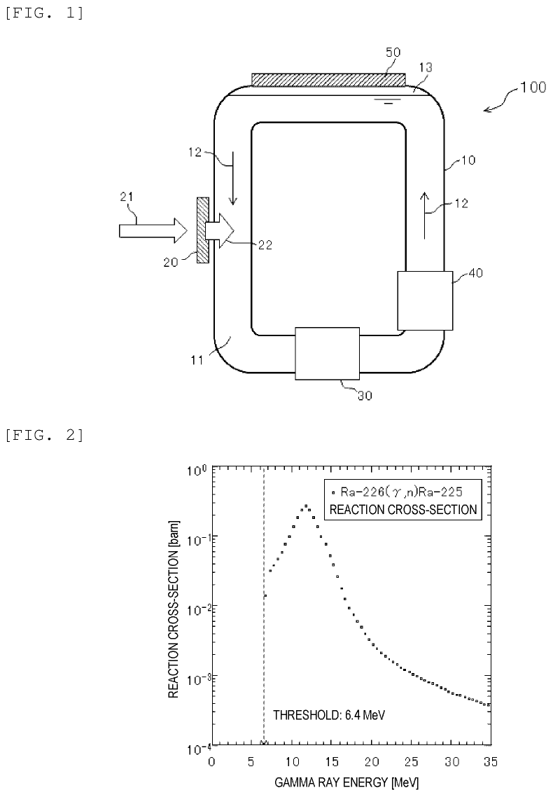

FIG. 1 is a schematic diagram showing an example of the radionuclide production system according to the invention.

As shown in FIG. 1, a radionuclide production system 100 includes a circulation path 10, a bremsstrahlung radiation generating target (a radiation generation unit) 20, a separation device (a separation unit) 30, a pump 40, and a metal member 50.

In the drawing, reference numeral 11 denotes a liquid containing a raw material nuclide or a generated nuclide in the circulation path. Reference numeral 12 denotes a flow direction of the liquid. Reference numeral 13 denotes a gas phase portion containing generated gas. Reference numeral 21 denotes an electron beam. Reference numeral 22 denotes bremsstrahlung radiation.

The radionuclide production system 100 is a device for producing a radionuclide by irradiating the liquid containing the raw material nuclide with the bremsstrahlung radiation. In the radionuclide production system 100, a predetermined raw material nuclide contained in the liquid is irradiated with bremsstrahlung radiation having energy equal to or greater than a threshold of a nuclear reaction, and the raw material nuclide is nuclear transformed to a target radionuclide by a photonuclear reaction caused by the bremsstrahlung radiation.

In the radionuclide production system 100, when water contained in the liquid 11 containing the raw material nuclide is subjected to radiolysis, in order to remove the oxygen gas and the hydrogen gas generated by the radiolysis of water by recombination reaction, the metal member 50 formed of a pure metal of the platinum group or an alloy of the platinum group is provided.

The production of the radionuclide in the radionuclide production system 100 is performed by the following method.

The liquid 11 containing the raw material nuclide is introduced into the circulation path 10 and circulated in the circulation path 10. When the nuclear transformation to the target radionuclide is advanced, the bremsstrahlung radiation generating target 20 is irradiated with a high-energy electron beam 21 from an electron beam irradiation device (not shown). The target 20 generates, by bremsstrahlung radiation caused by the electron beam 21, bremsstrahlung radiation 22 having energy equal to or greater than a threshold necessary for a nuclear reaction for generating the target radionuclide.

Then, the raw material nuclide contained in the liquid 11 is transformed to the target radionuclide by irradiating the liquid 11 containing the raw material nuclide with the bremsstrahlung radiation 22 while circulating the liquid 11 containing the raw material nuclide in the circulation path 10. Since the liquid 11 containing the raw material nuclide is circulated, the target radionuclide generated by the nuclear reaction flows through the circulation path 10 away from an irradiation region of the bremsstrahlung radiation 22 together with untransformed raw material nuclide.

The target radionuclide generated by the nuclear reaction is taken out continuously or intermittently from the circulation path 10 in the separation device 30 as necessary. The untransformed raw material nuclide further flows through the circulation path 10, is resupplied to the irradiation region of the bremsstrahlung radiation 22, and is irradiated with the bremsstrahlung radiation 22. The circulation of the liquid 11 containing the raw material nuclide and the irradiation with the bremsstrahlung radiation 22 can be continuously or intermittently repeated.

During the production of the radionuclide, oxygen and hydrogen generated by the radiolysis of the liquid 11 containing the raw material nuclide are removed by a recombination reaction with the metal member 50 at the upper portion in the circulation path 10. Since the metal member 50 is formed of a pure metal of the platinum group or an alloy of the platinum group, the metal member 50 has a catalytic activity of bonding oxygen and hydrogen to generate water. Therefore, even if oxygen and hydrogen are generated due to the radiolysis of water, oxygen and hydrogen return to water by the catalytic activity of the metal member 50, and the gas is removed from the circulation path 10.

As the raw material nuclide, an appropriate nuclide can be used according to the target radionuclide to be produced. Specific examples of the raw material nuclide include radium-226 (Ra-226), molybdenum 100 (Mo-100), zinc-68 (Zn-68), hafnium 178 (Hf-178), and germanium 70 (Ge-70).

As the nuclear reaction for the nuclear transformation of the raw material nuclide, a photonuclear reaction such as (γ,n), (γ,p), (γ,2n), (γ,pn), or the like can be used according to the target radionuclide to be produced, the type of the raw material nuclide, necessary energy, or the like.

The radionuclide produced by the nuclear reaction is not particularly limited, but is preferably an α-ray emitting nuclide, a β-ray emitting nuclide, or a γ-ray emitting nuclide from the viewpoint of being useful as a raw material of a therapeutic drug used for internal radiotherapy, a radioactive labeling reagent used for a radiation diagnosis, or the like. The produced radionuclide may be a descendant nuclide that is generated by radioactive decay after the photonuclear reaction.

For example, when actinium-225 (Ac-225) that is the α-ray emitting nuclide is to be produced, the reaction Ra-226(γ,n)Ra-225 and β-decay can be used. When technetium-99m (Tc-99m) that is the γ-ray emitting nuclide is to be produced, the reaction Mo-100(γ,n)Tc-99m can be used. When copper-67 (Cu-67) that is the β-ray and γ-ray emitting nuclide is to be produced, the reaction Zn-68 (γ,p)Cu-67 can be used. When lutetium-177 (Lu-177) that is the β-ray and γ-ray emitting nuclide is to be produced, the reaction Hf-178(γ,p)Lu-177 can be used. When gallium-68 (Ga-68) that is the β-ray emitting nuclide is to be produced, the reaction Ge-70(γ,2n)Ge-68 and an electron capture reaction can be used.

When the photonuclear reaction performed by the bremsstrahlung radiation is used for the production of the target radionuclide, enter particles having necessary energy can be generated by a small accelerator compared with a synchrotron, a cyclotron, or the like. In addition, since it is not necessary to provide a thick shielding material as compared with a case of using a nuclear reaction performed by neutrons or charged particles, it is possible to provide a small and lightweight device.

As the liquid 11 containing the raw material nuclide, a solution obtained by dissolving a substance containing the raw material nuclide in a solvent, a dispersion liquid obtained by dispersing a substance containing the raw material nuclide in a dispersion medium, or the like can be used. The liquid 11 containing the raw material nuclide may be a liquid having low viscosity or a slurry having a viscosity higher than that of water as long as it contains at least a trace amount of water. As the solvent or the dispersion medium, water, an acid solution, or the like can be used. Examples of the acid solution include a hydrochloric acid solution and a nitric acid solution.

As the substance containing the raw material nuclide, an appropriate chemical form can be used according to the type, solubility, dispersibility, and the like of the raw material nuclide. Specific examples of the substance containing the raw material nuclide include compounds such as an oxide, a nitride, a hydride, a carbide, a halide, a carbonate, a nitrate, an acetate, an ammonium salt, and a complex.

The liquid 11 containing the raw material nuclide preferably does not contain halogen derived from a raw material such as a halogen molecule, a halogen compound, or a halogen ion from the viewpoint of using the metal member 50 formed of a pure metal of the platinum group or an alloy of the platinum group. That is, the substance containing the raw material nuclide, the solvent, and the dispersion medium are preferably a substance containing no halogen. When halogen is not contained, poisoning of the metal member 50 can be avoided. Therefore, the oxygen gas and the hydrogen gas can be continuously and efficiently removed.

For example, as the substance containing Ra-226, radium chloride (RaCl₂), radium carbonate (RaCO₃), or the like can be used, and radium carbonate (RaCO₃) is more preferable. As a substance containing Mo-99, molybdenum trioxide (MoO₃) or the like can be used. As a substance containing Zn-68, zinc oxide (ZnO) or the like can be used.

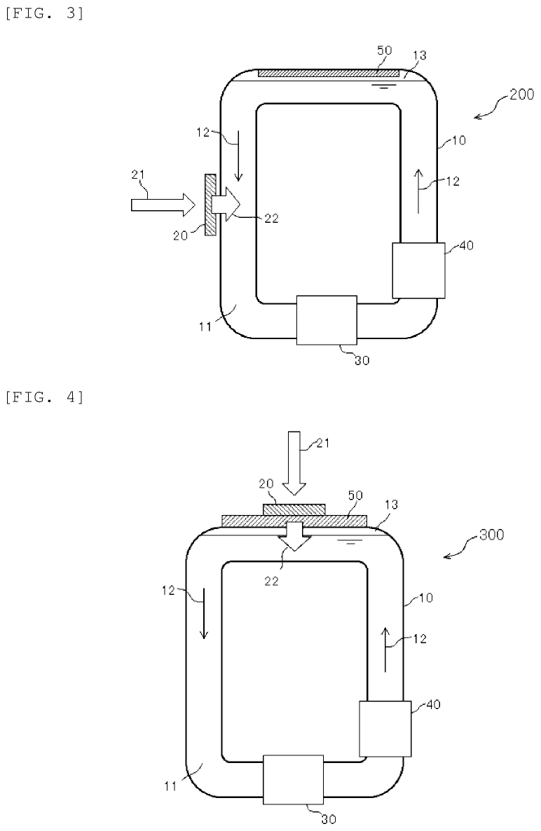

FIG. 2 is a graph showing theoretical values of a reaction cross-section of (γ,n) reaction of Ra-226.

As shown in FIG. 2, in the reaction Ra-226(γ,n)Ra-225, a threshold of energy required for the nuclear transformation of the raw material nuclide is 6.4 MeV. A reaction cross-section of the nuclear reaction is maximum due to giant resonance near 15 MeV to 20 MeV.

The bremsstrahlung radiation having such energy can be obtained when high-energy electrons accelerated by a linear accelerator or the like are subjected to bremsstrahlung radiation. An electron beam accelerator such as a linear accelerator can be provided in a smaller size than a proton accelerator or a heavy particle accelerator when the applied energy is the same.

In addition, the reaction cross-section of the reaction Ra-226(γ,n)Ra-225 is about the same as a reaction cross-section of the reaction Ra-226(p,2n)Ac-225. Therefore, when the photonuclear reaction performed by the bremsstrahlung radiation is used for production of Ac-225, the same amount of Ac-225 can be obtained by a smaller device as compared with a case of using a neutron generation reaction performed by a proton beam.

In addition, the reaction cross-section of the reaction Ra-226(n,2n)Ra-225 is slightly larger than the reaction cross-section of the reaction Ra-226(γ,n)Ra-225, but when the reaction Ra-226(γ,2n)Ra-225 is used, it is necessary to irradiate the raw material nuclide with high-speed neutrons. In order to generate the high-speed neutrons, it is necessary to irradiate a target of carbon or a target of a metal or the like in which tritium is occluded with deuterons accelerated by the cyclotron.

However, when the target is irradiated with deuterons, a large-scale cyclotron, a converging lens, or the like is required. In addition, since the neutrons having high energy transmit and scatter, equipment becomes radioactive, causing contamination or radioactive waste. In order to shield the transmitted and scattered neutrons, it is necessary to provide a thick shielding material.

In contrast, when the target is irradiated with the electron beam to generate the bremsstrahlung radiation, neutrons emitted from the target are reduced. In addition, the bremsstrahlung radiation emitted from the target can be relatively easily shielded by a shielding material such as lead. Therefore, the radionuclide can be produced by a small and lightweight device.

For example, in the case where the reaction Ra-226(γ,n)Ra-225 is used, when a liquid in which a substance containing Ra-226 is dissolved or dispersed is irradiated with the bremsstrahlung radiation 22, the substance containing Ra-226 is transformed to a substance containing Ra-225.

Ra-225 undergoes β-decay and becomes Ac-225 at a half-life of 14.8 days. Unreacted Ra-226 and un-decayed Ra-225 are mixed with each other, and are difficult to separate from each other since the unreacted Ra-226 and the un-decayed Ra-225 have the same chemical form. However, since Ra-225 is generated only in a trace amount as compared with Ra-226 at a normal transformation efficiency in the circulation path 10, the influence of re-irradiation with the bremsstrahlung radiation is small.

Ac-225 becomes Fr-221 at a half-life of 10.0 days. Fr-221 becomes At-217 at a half-life of 4.9 minutes. At-217 becomes Bi-213 at a half-life of 32 milliseconds. Ac-225 that is the α-ray emitting nuclide, and a descendant nuclide thereof are useful as raw materials of a therapeutic drug.

Ac-225 and a descendant nuclide thereof can be generated in the circulation path 10 and then taken out of the circulation path 10. On the other hand, Ra-226 and Ra-225 do not emit α-rays, and thus Ra-226 and Ra-225 are preferably separated and removed from Ac-225 or the like. In addition, Ra-226 is relatively expensive, and thus Ra-226 is preferably reused as the raw material nuclide after the separation.

As shown in FIG. 1, the circulation path 10 can be provided in a direction in which the liquid 11 containing the raw material nuclide is circulated in a vertical direction. In FIG. 1, a position of the irradiation region of the bremsstrahlung radiation 22 is, of sections in which the circulation path 10 extends in the vertical direction, a section in which the liquid 11 flows downward. The position of the irradiation region of the bremsstrahlung radiation 22 is not particularly limited to a position on the circulation path 10.

The circulation path 10 is a flow path for circulating the liquid 11 containing the raw material nuclide, and is formed in a closed annular shape by a structural member of, for example, a pipe shape. The circulation path 10 is provided in a liquid-tight and airtight manner to prevent leakage of the liquid 11 containing the raw material nuclide, or the radioactive substance. A shielding body that shields radiation can be provided outside the structural member that forms the circulation path 50 to surround the structural member.

As a material for the structural member forming the circulation path 10, for example, a suitable material, for example, stainless steel such as SUS 304 or SUS 316, an iron alloy, a nickel alloy, tungsten, or the platinum group can be used. The shielding body can be formed of an appropriate material, for example, a shielding material such as lead, iron, or an alloy thereof, or a composite material obtained by blending the shielding material with a resin, rubber, or the like.

When the circulation path 10 is provided, the liquid 11 containing the raw material nuclide can be circulated and the raw material nuclide in the liquid can be irradiated with the bremsstrahlung radiation 22. In general, the amount of the generated nuclides generated by the nuclear reaction is very small, and most of raw material nuclides remain untransformed. However, when the liquid 11 containing the raw material nuclide is circulated, the target radionuclide generated by the nuclear reaction can be taken out to the outside as necessary, and the untransformed raw material nuclides can be re-irradiated with the bremsstrahlung radiation 22. Therefore, the target radionuclide can be efficiently produced with high transformation efficiency.

In addition, when the circulation path 10 is provided, the liquid 11 containing the raw material nuclide can be circulated and can be irradiated with the bremsstrahlung radiation 22. Therefore, it is possible to prevent the temperature of the liquid 11 in the circulation path 10 from rising due to beam heating. In addition, a production amount of the target radionuclide can be easily adjusted based on the concentration, a circulation speed, or a circulation distance of the liquid 11 containing the raw material nuclide. In addition, a space in the circulation path 10 can be used for storing and holding the raw material nuclide or the radionuclide.

The bremsstrahlung radiation generating target 20 is formed of a material to be irradiated with charged particles to generate bremsstrahlung radiation. The target 20 can be formed of any appropriate material as long as it efficiently causes bremsstrahlung radiation. The target 20 can be provided in an appropriate structure such as a structure in which a plate-shaped or foil-shaped target member is fixed to a target holder, a structure in which the target member is embedded in the target, or a structure in which the target member is placed in a container.

It is preferable that the bremsstrahlung radiation generating target 20 is formed of a material having a large atomic number and a high density from the viewpoint of the ability of generating the bremsstrahlung radiation. Examples of preferable material for the target 20 include tungsten (W), tantalum (Ta), lead (Pb), bismuth (Bi), and a platinum group such as platinum (Pt), rhodium (Rh), palladium (Pd), ruthenium (Ru), and iridium (Ir).

The bremsstrahlung radiation generating target 20 is irradiated with the high-energy electron beam 21 from an electron beam irradiation device (not shown). As the electron beam irradiation device, a device including an electron source such as an electron gun and an accelerator for accelerating electrons is used. As the accelerator, a linear accelerator, a microtron, a betatron, or the like can be used. As the accelerator, a linear accelerator is preferable since a high-energy electron beam can be obtained by a small device.

In FIG. 1, the bremsstrahlung radiation generating target 20 is provided in proximity to the structural member forming the circulation path 10, and is provided separately from the metal member 50 and the structural member forming the circulation path 10. When provided separately, maintenance and management such as replacement become easy. The electron beam 21 to the target 20 and the bremsstrahlung radiation 22 from the target 20 are directed to enter the liquid 11 in the circulation path 10 from a lateral side of the circulation path 10.

In general, the electron beam is emitted from the accelerator in a horizontal direction. In addition, when making the electron beam enter the bremsstrahlung radiation generating target, the bremsstrahlung radiation is strongly emitted in the same direction as a traveling direction of the electron beam. In addition, a part of the electron beam transmits through the bremsstrahlung radiation generating target and generates a large thermal load behind the target, but from the viewpoint of reducing thermal load, it is desirable to make the electron beam enter the liquid.

When the electron beam 21 and the bremsstrahlung radiation 22 are directed to enter from the lateral side of the circulation path 10, the electron beam 21 and the bremsstrahlung radiation 22 can enter the liquid 11 in the circulation path 10 without deflecting a trajectory of the electron beam 21 emitted from the accelerator in the horizontal direction. Since a beam transport tube of a bent portion to be deflected, a deflection magnet, or the like are unnecessary, the device can be provided in small size and lightweight.

The separation device 30 is a device for separating the target radionuclide generated in the circulation path 10 from the raw material nuclide. The separation device 30 can be provided with an inlet through which a liquid to be treated flows in and an outlet through which a treated liquid after the separation treatment flows out. The inlet and the outlet can be connected in the middle of the circulation path 10 to provide the separation device 30 on the circulation path 10. In the separation device 30, the descendant nuclide generated by the radioactive decay of the radionuclide generated by the nuclear reaction may be separated.

As the separation device 30, a chromatograph, a centrifugal separator, a settling separator, an evaporation separator, or the like can be used according to the nuclide to be separated.

As a chromatograph, a column for liquid chromatography can be used. As the column, a column that has a high affinity to one of a chemical form including the raw material nuclide and a chemical form including the target radionuclide, and has a low affinity to the other one can be used. A stationary phase filled in the column may be any one of a solid, a liquid, a gel, and the like.

For example, in the chromatograph, if the chemical form including the raw material nuclide has an affinity to the stationary phase, a permeated liquid from the column is discharged to the outside of the circulation path 10 and recovered, and an eluate from the column is returned to the circulation path 10. When the chemical form including the target radionuclide has affinity to the stationary phase, the permeated liquid from the column is returned to the circulation path 10, and the eluate from the column is discharged to the outside of the circulation path 10 and recovered.

As a centrifugal separator, an appropriate device such as a disk type, a decanter type, or a cyclone type can be used. As a settling separator, an appropriate device such as a centrifugal settling type, a gravity settling type, a floating separation type, or a heavy liquid separation type can be used. In the centrifugal separator or the settling separator, a precipitating agent or a flocculating agent may be used. As the precipitating agent or the flocculating agent, one that strongly acts on one of the chemical form including the raw material nuclide and the chemical form including the target radionuclide, and that weakly or does not act on the other one can be used.

For example, in the centrifugal separator or the settling separator, when the chemical form including the raw material nuclide is precipitated, a supernatant fraction is discharged to the outside of the circulation path 10 and recovered, and a precipitated fraction is returned to the circulation path 10. When the chemical form including the target radionuclide is precipitated, a supernatant fraction is returned to the circulation path 10, and a precipitated fraction is discharged to the outside of the circulation path 10 and recovered.

As an evaporation separator, it is possible to use an appropriate device including an evaporator or a heating source that evaporates a liquid, a condenser that condenses vapor, and the like. In the evaporation separator, when there is a great difference in evaporation temperature between the chemical form including the raw material nuclide and the chemical form including the target radionuclide, the nuclides can be separated from each other by gas-liquid separation using the evaporation temperature difference.

For example, when the raw material nuclide is separated in a vapor side in the evaporation separator, an unevaporated liquid is discharged to the outside of the circulation path 10 and recovered, and the vapor is condensed and returned to the circulation path 10. When the target radionuclide is separated to the vapor side, the vapor is discharged to the outside of the circulation path 10 and recovered, and an unevaporated liquid is returned to the circulation path 10.

When the separation device 30 is provided, the target radionuclide generated in the liquid 11 containing the raw material nuclide can be separated from untransformed raw material nuclide. Therefore, while circulating the liquid 11 containing the raw material nuclide, the recovery of the target radionuclide and the irradiation to the untransformed raw material nuclide can be continued. Since the target radionuclide is sequentially taken out and the transformation efficiency of the nuclear transformation performed by the irradiation with the bremsstrahlung radiation 22 is improved, the target radionuclide can be efficiently produced.

The pump 40 circulates the liquid 11 in the circulation path 50. The pump 40 can be provided on the circulation path 10 by connecting, in the middle of the circulation path 10, a suction opening for suctioning the liquid and a discharge opening for discharging a pressurized liquid. A discharge rate of the pump 40 may be controlled, or an operation of the pump 40 may be turned on or off. As the pump 40, an appropriate pump such as a centrifugal pump, an axial flow pump, a mixed flow pump, or a jet pump can be used.

When the pump 40 is provided, the liquid 11 containing the raw material nuclide can be forcibly circulated in the circulation path 10. Therefore, the target radionuclide can be efficiently produced by continuing the irradiation performed with the bremsstrahlung radiation 22. In addition, since the liquid 11 behind the target 20 is forcibly replaced, it is possible to prevent the temperature of the liquid 11 from raising due to the electron beam 21 transmitted through the target 20.

The metal member 50 is formed of a pure metal of the platinum group or an alloy of the platinum group, and catalyzes the recombination reaction of bonding oxygen and hydrogen to generate water. The metal member 50 is provided at the upper portion in the circulation path 10. Since a platinum group has high radiation resistance and catalytic activity for generating water from oxygen and hydrogen, the metal member 50 is suitably provided in the circulation path 10. The metal member 50 is formed mainly of a platinum group, has a surface formed of a platinum group, and may have a portion formed of a material other than the platinum group.

Examples of a pure metal of the platinum group or an alloy of the platinum group include platinum (Pt), rhodium (Rh), palladium (Pd), ruthenium (Ru), iridium (Ir), and the like, and alloys containing platinum (Pt), rhodium (Rh), palladium (Pd), ruthenium (Ru), iridium (Ir), and the like as main components. As the metal member 50, one kind of pure metal or alloy may be provided, or a plurality of kinds of pure metals or alloys may be provided.

The upper portion in the circulation path 10 is a place where, when the oxygen gas or the hydrogen gas is generated due to the radiolysis of water, the gases rising in the liquid tends to accumulate. The upper portion in the circulation path 10 includes an inner side of the structural member with a pipe shape or the like forming the circulation path 10, that is a place where the gas may come into contact with, such as a surface of the structural member located at a ceiling portion of the circulation path 10, a surface of a side portion in proximity to the ceiling portion of the circulation path 10, or an upper space in proximity to the ceiling portion of the circulation path 10.

When the liquid 11 containing the raw material nuclide is irradiated with the bremsstrahlung radiation 22, at least a part of water contained in the liquid 11 may be subjected to radiolysis. When water is subjected to the radiolysis, the oxygen gas and the hydrogen gas are generated. Since the gases are lighter than the liquid 11 in the circulation path 10, the gases rise in the liquid and accumulate in the upper portion in the circulation path 10. When the generation amount of the gases is large, a gas phase portion 13 is formed in the upper portion in the circulation path 10.

When the gases accumulate in the circulation path 10, the pressure in the circulation path 10 increases, and leakage of the liquid 11 containing the raw material nuclide, leakage of radioactive substances such as the raw material nuclide, the target radionuclide, and the descendant nuclides thereof, rupture of the structural member of the pipe shape forming the circulation path 10, or the like may occur. The occurrence of leakage, rupture, or the like leads to diffusion of the radioactive substance and exposure to radiation to a manufacturer. In addition, since a composition ratio, the temperature, and the pressure of the oxygen gas and the hydrogen gas may fall within a range of an explosion limit in the circulation path 50, hydrogen explosion may occur.

For example, when the reaction Ra-226(γ,n)Ra-225 is used, not only the bremsstrahlung radiation but also a rays emitted from Ac-225 and the descendant nuclide thereof cause the radiolysis of water, thereby generating a large amount of the oxygen gas and the hydrogen gas. Ra-226 becomes Rn-222 by α-decay. Rn-222 exists as a monoatomic molecule gas. Therefore, when leakage, rupture, or the like occurs in the circulation path 10, the gas Rn-222 may also diffuse into the environment.

When 50 GBq of Ra-226 is used as the raw material nuclide, 5.0×10¹⁰ Rn-222 are generated per second by the α-decay. Rn-222 becomes a descendant nuclide with a half-life of 3.8 days. Many descendant nuclides are of a solid chemical form. Therefore, an amount of the gas generated by the radioactive decay of Ra-226 is smaller than that of the gases generated by the radiolysis of water. It can be said that the raw material nuclide such as Ra-226 has less influence on an increase in pressure than water in the liquid.

However, when leakage, rupture, or the like occurs in the circulation path 10, a trace amount of Rn-222 is also discharged to the outside. When the gas Rn-222 is discharged, that is concern that the descendant nuclide after the radioactive decay adheres to the environment when the descendant nuclide becomes a solid chemical form. Since the radionuclide adhering to the environment continues to contaminate the surroundings, it is desired to prevent the increase in the pressure in the circulation path 10.

It is also considered that the gas generated in the circulation path 10 is discharged to the outside in a stage when a predetermined pressure is reached before leakage, rupture, or the like occurs. However, when the gas is to be discharged, it is necessary to provide a gas discharge opening in the circulation path 10 and provide a radioactive gas treatment device to remove radioactive substances in the gas to be discharged. In general, the radioactive gas treatment device includes a large-scale filter, an adsorption tower, a monitoring device, and the like. Therefore, when the radioactive gas treatment device is provided, an increase in size and weight of the entire system becomes a problem.

With respect to such a problem, when the metal member 50 formed of a pure metal of the platinum group or an alloy of the platinum group is provided in the upper portion in the circulation path 10, even if the radiolysis of water occurs to generate the oxygen gas and the hydrogen gas, oxygen and hydrogen can be subjected to the recombination reaction and returned to water. Since the oxygen gas and the hydrogen gas are less likely to be accumulated in the circulation path 10, an increase in the pressure in the circulation path 10 is prevented.

Therefore, when the metal member 50 is provided at the upper portion in the circulation path 10, it is possible to prevent leakage of the liquid 11 in the circulation path 10 due to excessive pressure, leakage of radioactive substances such as the raw material nuclide, the target radionuclide, and the descendant nuclides thereof, and rupture of the structural member of the pipe shape forming the circulation path 10. Diffusion of the radioactive substance and exposure of a manufacturer are prevented. In addition, an amount of oxygen-hydrogen mixed gas accumulated in the circulation path 10 can be decreased to reduce the risk of hydrogen explosion.

In FIG. 1, the metal member 50 is provided integrally with the structural member forming the circulation path 10. The metal member 50 is disposed on a ceiling portion of a section on an upper portion of the circulation path 10 to be exposed to the inside of the circulation path 10.

When the metal member 50 is provided integrally with the structural member forming the circulation path 10, a fine groove, a fine hole, and the like formed of a platinum group can be provided in the surface of the structural member forming the circulation path 10. When the fine groove, the fine hole, and the like formed of a platinum group are provided, a large surface area is obtained. Therefore, a reaction efficiency of the recombination reaction is increased.

In the structural member in which the fine groove, the fine hole, and the like formed of a platinum group are provided in the surface, only a part including surfaces of the fine groove, the fine hole, and the like may be formed of the platinum group, or the entire structural member may be formed of the platinum group. As a method of forming a part by a platinum group, a method of bonding a covering member of a platinum group by pressure bonding, a method of plating a platinum group, or the like can be used.

According to such a radionuclide production system 100 and a radionuclide production method using the system, since the metal member 50 is provided at the upper portion of the circulation path 10, accumulation of the oxygen gas and the hydrogen gas due to the radiolysis of water is prevented. In the production using the circulation path 10 capable of efficiently producing the radionuclide, it is not necessary to provide a large-scale radioactive gas treatment device to discharge the gas, and leakage of the liquid 11 containing the raw material nuclide, leakage of the radioactive substances, rupture of the structural member of the pipe shape forming the circulation path 10, and the like are prevented. As a result, diffusion of the radioactive substance, exposure of a manufacturer, and hydrogen explosion are prevented. Therefore, the radionuclide can be efficiently produced by a small, lightweight, and highly safe device.

In particular, according to the radionuclide production system 100, the metal member 50 is provided integrally with the structural member forming the circulation path 10, and thus it is possible to reduce pressure loss with respect to the liquid 11 in the circulation path 10 due to the metal member 50 and deposition of a dispersion substance or the like on the surface of the metal member 50 as compared with a case where the metal member 50 is attached, as a component, inside the structural member of the pipe shape forming the circulation path 10.

FIG. 3 is a schematic diagram showing an example of a radionuclide production system according to the invention.

As shown in FIG. 3, the metal member 50 may be attached, as a component, inside the structural member of the pipe shape forming the circulation path 10. FIG. 3 shows a radionuclide production system 200 including such a metal member 50.

Similar to the radionuclide production system 100, the radionuclide production system 200 includes the circulation path 10, the bremsstrahlung radiation generating target (a radiation generation unit) 20, the separation device (a separation unit) 30, the pump 40, and the metal member 50. A main configuration of the radionuclide production system 200 is substantially the same as that of the radionuclide production system 100 except for the form of the metal member 50.

In FIG. 3, the bremsstrahlung radiation generating target 20 is provided in proximity to the structural member forming the circulation path 10, and is provided separately from the metal member 50 and the structural member forming the circulation path 10. The electron beam 21 and the bremsstrahlung radiation 22 are directed to enter the liquid 11 in the circulation path 10 from a lateral side of the circulation path 10. The circulation path 10 is provided in a direction in which the liquid 11 containing the raw material nuclide is circulated in the vertical direction.

In the radionuclide production system 200, the metal member 50 is attached as a component in the upper portion of the circulation path 10. The metal member 50 serving as a component is disposed at a position in proximity to the ceiling portion of the section on the upper portion of the circulation path 10 to be exposed to the inside of the circulation path 10. The metal member 50 serving as a component can be attached by an appropriate method such as welding, brazing, or mechanical joining performed using a joining component.

When the metal member 50 is attached as a component in the upper portion of the circulation path 10, a mesh formed of a single or bundle thin wire formed of a platinum group or a thin wire formed of a platinum group, a mesh formed of a thin wire, a member obtained by plating an expanded metal, a punched metal, or the like with a platinum group, a member obtained by making a carrier made of metal, ceramics, or the like support particles of the platinum group can be used as the metal member 50. According to the metal members 50, a large surface area is obtained. Therefore, the reaction efficiency of the recombination reaction can be improved.

According to such a radionuclide production system 200 and a radionuclide production method using the system, similar to the case of the radionuclide production system 100, the radionuclide can be efficiently produced by a small, lightweight, and highly safe device. In particular, since the metal member 50 is attached as a component to the inside of the structural member of the pipe shape forming the circulation path 10, it is possible to easily perform replacement, cleaning, regeneration, and the like on the metal member 50 as compared with the case where the metal member 50 is provided integrally with the structural member forming the circulation path 10.

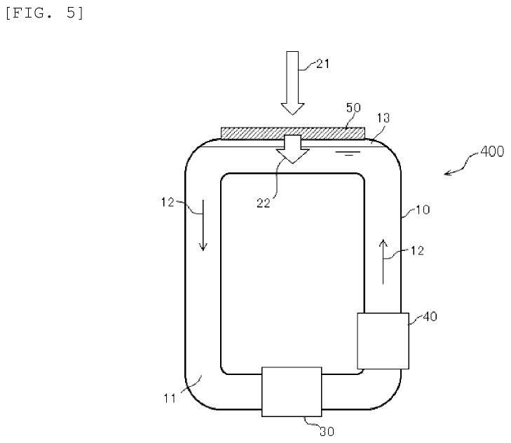

FIG. 4 is a schematic diagram showing an example of a radionuclide production system according to the invention.

As shown in FIG. 4, the electron beam 21 and the bremsstrahlung radiation 22 may be directed to enter the liquid 11 in the circulation path 10 from above the circulation path 10. FIG. 4 shows a radionuclide production system 300 having such a configuration.

Similar to the radionuclide production system 100, the radionuclide production system 300 includes the circulation path 10, the bremsstrahlung radiation generating target (a radiation generation unit) 20, the separation device (a separation unit) 30, the pump 40, and the metal member 50. A main configuration of the radionuclide production system 300 is substantially the same as that of the radionuclide production system 100 except for arrangement of the target 20 and the like.

In FIG. 4, the metal member 50 is provided integrally with the structural member forming the circulation path 10. The metal member 50 is disposed on the ceiling portion of the section on the upper portion of the circulation path 10 to be exposed to the inside of the circulation path 10. The circulation path 10 is provided in a direction in which the liquid 11 containing the raw material nuclide is circulated in the vertical direction.

The bremsstrahlung radiation generating target 20 is provided in proximity to the structural member forming the circulation path 10, and is provided separately from the metal member 50 and the structural member forming the circulation path 10. The target 20 is disposed above the metal member 50 disposed on the upper portion of the circulation path 10. The target 20 and the metal member 50 are coaxially disposed between an irradiation opening of the electron beam 21 and the irradiation region of the bremsstrahlung radiation 22 on the circulation path 10.

In the radionuclide production system 300, the electron beam 21 is directed to enter the liquid 11 in the circulation path 10 from above the circulation path 10. In such a direction, the metal member 50 provided on the upper portion of the circulation path 10 behind the target 20 is also irradiated with a part of the electron beam 21 emitted from above to the bremsstrahlung radiation generating target 20. When the metal member 50 is irradiated with the electron beam 21, a part of energy of the electron beam 21 is applied to heat the metal member 50.

In general, the electron beam is emitted from the accelerator in a horizontal direction. Therefore, a trajectory of the electron beam 21 from the electron beam irradiation device may be deflected so that the electron beam 21 enters the target 20 from above. In addition, in general, when making the electron beam enter the bremsstrahlung radiation generating target, the bremsstrahlung radiation is strongly emitted in the same direction as a traveling direction of the electron beam. Therefore, the bremsstrahlung radiation 22 is also directed to enter the liquid 11 in the circulation path 10 from above the circulation path 10.

It is preferable to emit the electron beam 21 with energy with which the electron beam 21 loses the entire energy in the metal member 50 or behind the metal member 50. In addition, it is preferable to emit the electron beam 21 with energy with which the electron beam 21 cannot pass through the liquid 11 in the circulation path 10. When the electron beam 21 with such energy is emitted, the electron beam 21 can enter the circulation path 10 while reducing concentration of heat load.

According to such a radionuclide production system 300 and a radionuclide production method using the system, similar to the case of the radionuclide production system 100, the radionuclide can be efficiently produced by a small, lightweight, and highly safe device. In particular, the electron beam 21 and the bremsstrahlung radiation 22 may be directed to enter the liquid 11 in the circulation path 10 from above the circulation path 10. Therefore, the metal member 50 can also be irradiated with the electron beam 21. When the metal member 50 is irradiated with the electron beam 21 and heated to an appropriate temperature, the catalytic activity of the recombination reaction is increased, and thus a removal rate of the oxygen gas and the hydrogen gas can be improved.

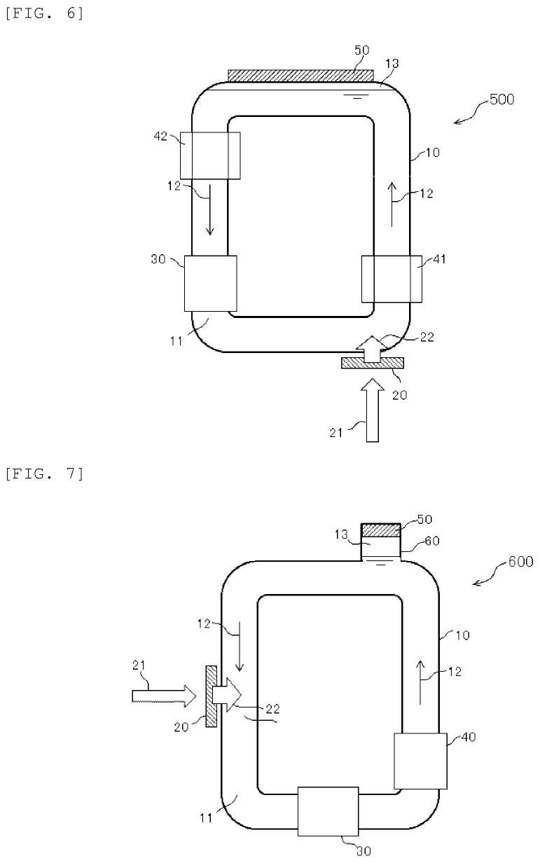

FIG. 5 is a schematic diagram showing an example of a radionuclide production system according to the invention.

As shown in FIG. 5, the metal member 50 may function as the bremsstrahlung radiation generating target (the radiation generation unit). That is, the metal member 50 may have not only a function of catalyzing the recombination reaction but also a function of generating the bremsstrahlung radiation 22 by being irradiated with the electron beam 21. FIG. 5 shows a radionuclide production system 400 having such a configuration.

Similar to the radionuclide production system 300, the radionuclide production system 400 includes the circulation path 10, the separation device (a separation unit) 30, the pump 40, and the metal member 50. A main configuration of the radionuclide production system 400 is substantially the same as that of the radionuclide production system 300 except for a configuration of the radiation generation unit.

In FIG. 5, the metal member 50 is provided integrally with the structural member forming the circulation path 10. The metal member 50 is disposed on the ceiling portion of the section on the upper portion of the circulation path 10 to be exposed to the inside of the circulation path 10. The electron beam 21 and the bremsstrahlung radiation 22 are directed to enter the liquid 11 in the circulation path 10 from above the circulation path 10. The circulation path 10 is provided in a direction in which the liquid 11 containing the raw material nuclide is circulated in the vertical direction.

In the radionuclide production system 400, not the bremsstrahlung radiation generating target 20 but the metal member 50 provided on the upper portion of the circulation path 10 is irradiated with the electron beam 21. The metal member 50 is irradiated with the electron beam 21 from above. Since the metal member 50 is formed of a pure metal of the platinum group or an alloy of the platinum group, it is possible to generate the bremsstrahlung radiation 22 by the bremsstrahlung radiation caused by the electron beam 21.

In general, the electron beam is emitted from the accelerator in a horizontal direction. Therefore, a trajectory of the electron beam 21 from the electron beam irradiation device may be deflected so that the electron beam 21 enters the metal member 50 from above. In addition, in general, when making the electron beam enter the target member, the bremsstrahlung radiation is strongly emitted in the same direction as the traveling direction of the electron beam. Therefore, the bremsstrahlung radiation 22 is also directed to enter the liquid 11 in the circulation path 10 from above the circulation path 10.

It is preferable to emit the electron beam 21 with energy with which the electron beam 21 loses the entire energy in the metal member 50 or behind the metal member 50. In addition, it is preferable to emit the electron beam 21 with energy with which the electron beam 21 cannot pass through the liquid 11. When the electron beam 21 with such energy is emitted, the electron beam 21 can enter the circulation path 10 while reducing concentration of heat load.

As the metal member 50, when the metal member 50 also has a function of generating the bremsstrahlung radiation, a structural member in which a fine groove, a fine hole, and the like formed of a platinum group are provided in a surface can be used. In such a structural member, only a part including surfaces of the fine groove, the fine hole, and the like may be formed of a platinum group, or the entire structural member may be formed of a platinum group, and it is preferable that the structural member is provided to have an appropriate thickness capable of ensuring a bremsstrahlung radiation amount. A thin wire, a mesh, a member plated with a platinum group, a member obtained by making a carrier support particles of the platinum group, and the like are used in combination as the metal member 50.

According to such a radionuclide production system 400 and a radionuclide production method using the system, similar to the case of the radionuclide production system 100, the radionuclide can be efficiently produced by a small, lightweight, and highly safe device. In particular, since the metal member 50 generates the bremsstrahlung radiation 22, it is not necessary to provide the bremsstrahlung radiation generating target separately from the metal member 50. Therefore, the device can be reduced in size and weight as compared with the case where the target is provided. In addition, since the metal member 50 is irradiated with the electron beam 21, the metal member 50 is heated by the beam. When the metal member 50 is irradiated with the electron beam 21 and heated to an appropriate temperature, the catalytic activity of the recombination reaction is increased, and thus a removal rate of the oxygen gas and the hydrogen gas can be improved.

FIG. 6 is a schematic diagram showing an example of a radionuclide production system according to the invention.

As shown in FIG. 6, the electron beam 21 and the bremsstrahlung radiation 22 may be directed to enter the liquid 11 in the circulation path 10 from below the circulation path 10. FIG. 6 shows a radionuclide production system 500 having such a configuration.

Similar to the radionuclide production system 100, the radionuclide production system 500 includes the circulation path 10, the bremsstrahlung radiation generating target (a radiation generation unit) 20, the separation device (a separation unit) 30, and the metal member 50. In addition, a heater 41 and a cooler 42 are provided. A main configuration of the radionuclide production system 500 is substantially the same as that of the radionuclide production system 100 except for arrangement of the target 20 and the like and including the heater 41 and the cooler 42 instead of the pump 40.

In FIG. 6, the metal member 50 is provided integrally with the structural member forming the circulation path 10. The metal member 50 is disposed on the ceiling portion of the section on the upper portion of the circulation path 10 to be exposed to the inside of the circulation path 10. The circulation path 10 is provided in a direction in which the liquid 11 containing the raw material nuclide is circulated in the vertical direction.

The bremsstrahlung radiation generating target 20 is provided in proximity to the structural member forming the circulation path 10, and is provided separately from the metal member 50 and the structural member forming the circulation path 10. The target 20 is disposed below a section on a lower portion of the circulation path 10. The target 20 is preferably disposed below a section of the circulation path 10 extending in the vertical direction.

In the radionuclide production system 500, the electron beam 21 is directed to enter the liquid 11 in the circulation path 10 from below the circulation path 10. In such a direction, the liquid 11 containing the raw material nuclide in the section on the lower portion of the circulation path 10 behind the target 20 is also irradiated with a part of the electron beam 21 emitted from above to the bremsstrahlung radiation generating target 20.

When the liquid 11 is irradiated with the electron beam 21, the liquid 11 containing the raw material nuclide in the section on the lower portion of the circulation path 10 is heated. When the liquid 11 is heated, the volume expands and the density decreases, and an upward flow is generated in the circulation path 10. Therefore, even if the pump 40 is omitted, a circulating flow of the liquid 11 in the circulation path 10 can be biased.

In general, the electron beam is emitted from the accelerator in the horizontal direction. Therefore, a trajectory of the electron beam 21 from the electron beam irradiation device may be deflected so that the electron beam 21 enters the target 20 from below. In addition, in general, when making the electron beam enter the bremsstrahlung radiation generating target, the bremsstrahlung radiation is strongly emitted in the same direction as a traveling direction of the electron beam. Therefore, the bremsstrahlung radiation 22 is also directed to enter the liquid 11 in the circulation path 10 from below the circulation path 10.

It is preferable to emit the electron beam 21 with energy with which the electron beam 21 loses the entire energy in the circulation path 10 behind the target 20. In addition, it is preferable to emit the electron beam 21 with energy with which the electron beam 21 cannot pass through the liquid 11 in the circulation path 10. When the electron beam 21 with such energy is emitted, the electron beam 21 can enter the circulation path 10, thereby heating the liquid 11 in the circulation path 10 while reducing the concentration of the heat load.

The heater 41 is a device for heating the liquid 11 in the circulation path 50. The heater 41 can be provided on the circulation path 10 or around the structural member forming the circulation path 10. The heater 41 is preferably disposed on a lower portion of a section of the circulation path 10 extending in the vertical direction. As the heater 41, an appropriate device such as an electric heater of, for example, a jacket type, a cord winding type, or a seed embedding type, or a heat exchanger of, for example, a jacket type or a tube type can be used.

When the heater 41 is provided, the liquid 11 in the circulation path 50 can be forcibly heated to generate an upward flow in the circulation path 50. Therefore, even if the pump 40 is omitted, a circulating flow of the liquid 11 in the circulation path 10 can be biased. When the liquid 11 in the circulation path 10 is circulated by the irradiation performed with the electron beam 21, the installation of the heater 41 may be omitted.

The cooler 42 is a device for cooling the liquid 11 in the circulation path 50. The cooler 42 can be provided on the circulation path 10 or around the structural member forming the circulation path 10. The cooler 42 is preferably disposed on an upper portion of a section of the circulation path 10 extending in the vertical direction on a side opposite to the section where the heater 41 is provided. As the cooler 42, an appropriate device such as a heat exchanger of, for example, a jacket type or a tube type can be used.

When the cooler 42 is provided, the liquid 11 in the circulation path 50 can be forcibly cooled to generate a downward flow in the circulation path 50. Therefore, even if the pump 40 is omitted, a circulating flow of the liquid 11 in the circulation path 10 can be biased. When the liquid 11 in the circulation path 10 circulates by natural heat dissipation, the cooler 42 may be omitted.

According to such a radionuclide production system 500 and a radionuclide production method using the system, similar to the case of the radionuclide production system 100, the radionuclide can be efficiently produced by a small, lightweight, and highly safe device. In particular, since the electron beam 21 and the bremsstrahlung radiation 22 are directed to enter the liquid 11 in the circulation path 10 from below the circulation path 10, the liquid 11 in a lower portion in the circulation path 10 can also be irradiated with the electron beam 21. When the liquid 11 is heated by the irradiation performed with the electron beam 21, the liquid 11 can be circulated without using a pump.

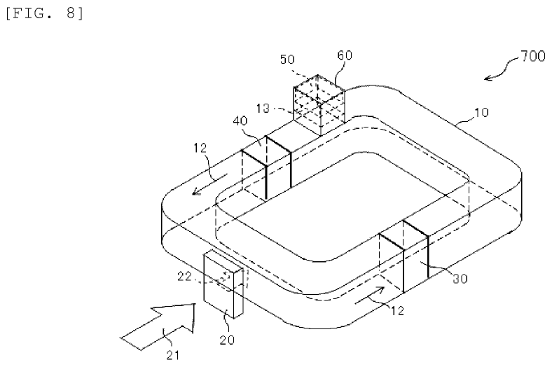

FIG. 7 is a schematic diagram showing an example of a radionuclide production system according to the invention.

As shown in FIG. 7, a gas chamber 60 in which gas is retained may be provided in an upper portion of the circulation path 50, and the metal member 30 may be provided in the gas chamber 60. FIG. 7 shows a radionuclide production system 600 having such a configuration.

Similar to the radionuclide production system 100, the radionuclide production system 600 includes the circulation path 10, the bremsstrahlung radiation generating target (a radiation generation unit) 20, the separation device (a separation unit) 30, the pump 40, and the metal member 50. A main configuration of the radionuclide production system 600 is substantially the same as that of the radionuclide production system 100 except for the gas chamber 60 and the arrangement of the metal member 50.

In FIG. 7, the bremsstrahlung radiation generating target 20 is provided in proximity to the structural member forming the circulation path 10, and is provided separately from the metal member 50 and the structural member forming the circulation path 10. The electron beam 21 and the bremsstrahlung radiation 22 are directed to enter the liquid 11 in the circulation path 10 from a lateral side of the circulation path 10. The circulation path 10 is provided in a direction in which the liquid 11 containing the raw material nuclide is circulated in the vertical direction.

In the radionuclide production system 600, the gas chamber 60 is provided in the upper portion of the circulation path 10. The gas chamber 60 is provided above the ceiling portion of the section on the upper portion of the circulation path 10 as a space communicating with a closed-loop portion of the circulation path 10. The oxygen gas and the hydrogen gas generated by the radiolysis of water can be separated from the liquid 11 in the closed-loop portion of the circulation path 10 and flow into the gas chamber 60. The liquid 11 containing the raw material nuclide is introduced, for example, up to the height of the ceiling portion of the closed-loop portion of the circulation path 10. With such a liquid amount, the gas phase portion 13 is maintained in the gas chamber 60.

The metal member 50 is attached, as a component, in an upper portion of the gas chamber 60. The metal member 50 serving as a component is disposed in the gas phase portion 13 in proximity to a ceiling portion of the gas chamber 60 so as not to be in contact with the liquid 11 containing the raw material nuclide. The metal member 50 serving as a component can be attached in the upper portion of the gas chamber 60 by an appropriate method such as welding, brazing, or mechanical joining performed using a joining component.

When the metal member 50 is attached as a component in the gas chamber 60, a mesh formed of a single or bundle thin wire formed of a platinum group or a thin wire formed of a platinum group, a mesh formed of a thin wire, a member obtained by plating an expanded metal, a punched metal, or the like with a platinum group, a member obtained by making a carrier made of metal, ceramics, or the like support particles of the platinum group can be used as the metal member 50. According to the metal members 50, a large surface area is obtained. Therefore, the reaction efficiency of the recombination reaction can be improved.

In FIG. 7, the metal member 50 is attached, as a component, in the upper portion of the gas chamber 60, and the metal member 50 may be provided integrally with a structural member forming the gas chamber 60. In addition, the metal member 50 serving as a component or the metal member 50 serving as a structural member is not limited to the upper portion of the gas chamber 60, and may be provided in a side portion of the gas chamber 60 or a lower portion of the gas chamber 60 as long as the metal member 50 does not in contact with the liquid 11 containing the raw material nuclide.

According to such a radionuclide production system 600 and a radionuclide production method using the system, similar to the case of the radionuclide production system 100, the radionuclide can be efficiently produced by a small, lightweight, and highly safe device. In particular, since the metal member 30 is provided in the gas chamber 60 provided in an upper portion of the circulation path 10, it is possible to prevent the metal member 50 and the liquid 11 containing the raw material nuclide from being in contact with each other. Even if the liquid 11 in the circulation path 10 contains halogen, since halogen does not in contact with the metal member 50, poisoning due to the metal member 50 can be avoided.

FIG. 8 is a schematic diagram showing an example of a radionuclide production system according to the invention.

As shown in FIG. 8, the circulation path 10 may be configured to circulate the liquid 11 containing the raw material nuclide in the horizontal direction. FIG. 8 shows a radionuclide production system 700 having such a configuration.

Similar to the radionuclide production system 600, the radionuclide production system 700 includes the circulation path 10, the bremsstrahlung radiation generating target (a radiation generation unit) 20, the separation device (a separation unit) 30, the pump 40, the metal member 50, and the gas chamber 60. A main configuration of the radionuclide production system 700 is substantially the same as that of the radionuclide production system 600 except for the form of the circulation path 10.

In FIG. 8, the bremsstrahlung radiation generating target 20 is provided in proximity to the structural member forming the circulation path 10, and is provided separately from the metal member 50 and the structural member forming the circulation path 10. The target 20 is disposed at a lateral side of the circulation path 10. The electron beam 21 and the bremsstrahlung radiation 22 are directed to enter the liquid 11 in the circulation path 10 from the lateral side of the circulation path 10.

In the radionuclide production system 700, the circulation path 10 has a closed-loop portion parallel to the horizontal direction and is provided in a direction in which the liquid 11 containing the raw material nuclide is circulated in the horizontal direction. The gas chamber 60 is provided on an upper portion of the horizontal circulation path 10. The gas chamber 60 is provided above a ceiling portion of the closed-loop portion of the circulation path 10 as a space communicating with the closed-loop portion of the circulation path 10.

The oxygen gas and the hydrogen gas generated by the radiolysis of water can be separated from the liquid 11 in the closed-loop portion of the circulation path 10 and flow into the gas chamber 60. The liquid 11 containing the raw material nuclide is introduced to, for example, the height of the ceiling portion of the closed-loop portion of the circulation path 10. With such a liquid amount, the gas phase portion 13 is maintained in the gas chamber 60.

In FIG. 8, the gas chamber 60 is provided in a section between the separation device 30 and the pump 40. With such an arrangement, it is possible to reduce the irradiation performed with the bremsstrahlung radiation 22 to the gas and flow of the gas into the pump 40. However, the gas chamber 60 may be provided in a section between the irradiation region of the bremsstrahlung radiation 22 and the separation device 30, a section between the pump 40 and the irradiation region of the bremsstrahlung radiation 22, or the like. In addition, the gas chamber 60 may be provided above a section of a part of the circulation path 10 or may be provided above a section of the entire circulation path 10.

The metal member 50 is attached, as a component, in an upper portion of the gas chamber 60. The metal member 50 serving as a component is disposed in the gas phase portion 13 of the gas chamber 60 so as not to be in contact with the liquid 11 containing the raw material nuclide. The metal member 50 serving as a component can be attached in the gas chamber 60 by an appropriate method such as welding, brazing, or mechanical joining performed using a joining component.

When the metal member 50 is attached as a component in the gas chamber 60, a mesh formed of a single or bundle thin wire formed of a platinum group or a thin wire formed of a platinum group, a mesh formed of a thin wire, a member obtained by plating an expanded metal, a punched metal, or the like with a platinum group, a member obtained by making a carrier made of metal, ceramics, or the like support particles of the platinum group can be used as the metal member 50. According to the metal members 50, a large surface area is obtained. Therefore, the reaction efficiency of the recombination reaction can be improved.

In FIG. 8, the metal member 50 is attached, as a component, in the upper portion of the gas chamber 60, and the metal member 50 may be provided integrally with a structural member forming the gas chamber 60. In addition, the metal member 50 serving as a component or the metal member 50 serving as a structural member is not limited to the upper portion of the gas chamber 60, and may be provided in a side portion of the gas chamber 60 or a lower portion of the gas chamber 60 as long as the metal member 50 does not come into contact with the liquid 11 containing the raw material nuclide.

According to such a radionuclide production system 700 and a radionuclide production method using the system, similar to the case of the radionuclide production system 100, the radionuclide can be efficiently produced by a small, lightweight, and highly safe device. In particular, since the circulation path 10 for circulating the liquid 11 containing the raw material nuclide in the horizontal direction is provided, it is possible to circulate the liquid 11 containing the raw material nuclide by a pump having a low output power as compared with the case of circulating the liquid 11 in the vertical direction.

Although the embodiments of the invention have been described above, the invention is not limited to the embodiments described above, and various modifications can be made without departing from the spirit of the invention. For example, the invention is not necessarily limited to those including all the configurations in the embodiments described above. A part of a configuration of an embodiment may be replaced with another configuration, may be added to another embodiment, or may be omitted.

For example, in the radionuclide production systems 300 to 700, the metal member 50 serving as a structural member, the metal member 50 serving as a component, or a combination thereof may be provided in the upper portion in the circulation path 10.

In addition, the radionuclide production systems 100 and 200 may be configured such that a solution containing the raw material nuclide in the circulation path 10 is irradiated from above or below the circulation path 10 with the electron beam 21 and the bremsstrahlung radiation 22.

In addition, the radionuclide production systems 100 to 400 may be configured to circulate the liquid 11 containing the raw material nuclide in the horizontal direction by the circulation path 10. The metal member 50 may be provided in an upper portion of a partial section or the entire section of the upper portion of the horizontal circulation path 10.

In addition, in the radionuclide production systems 100 to 300 and 500 to 700, the bremsstrahlung radiation generating target 20 is provided separately from the structural member forming the circulation path 10, and may be provided integrally with the structural member forming the circulation path 10. When the bremsstrahlung radiation generating target 20 is integrally provided with the structural member forming the circulation path 10, the circulation path 10 and the target 20 can be efficiently produced.

In addition, in the radionuclide production systems 100 to 400, 600, and 700, the bremsstrahlung radiation 22 may enter in parallel to a linearly extending section of the circulation path 10. For example, the bremsstrahlung radiation 22 can be emitted to pass through the vicinity of a central axis of the section on the upper portion of the circulation path 10, the vicinity of a central axis of the section on the lower portion, or the vicinity of a central axis of the section on a side portion of the circulation path 10. When making the bremsstrahlung radiation 22 enter a linear section in parallel, a reaction amount of the bremsstrahlung radiation 22 and the raw material nuclide increases. Therefore, the target radionuclide can be efficiently produced.

In addition, in the radionuclide production systems 100 to 700, the circulation path 10 is provided in a substantially rectangular closed annular shape, and a flow path shape and a path shape of the circulation path 10 are not particularly limited. The circulation path 10 may include, in addition to the section of the pipe shape, a section of a chamber shape having an enlarged flow path width, a channel shape embedded in a structural member and the like. In addition, the circulation path 10 may be provided in a circular shape, a combination of a circular portion and a rectangular portion, a two-dimensional closed-loop shape such as a meandering shape, or a three-dimensional closed-loop shape.

In addition, the circulation path 10 may be provided with a detour with respect to the closed-loop portion. For example, the detour that bypasses the separation device is connected to the closed-loop portion of the circulation path 10, and whether to take out the target radionuclide can be switched by the flow path.

### REFERENCE SIGNS LIST

100: radionuclide production system
10: circulation path
11: liquid containing raw material nuclide or generated nuclide in circulation path
12: flow direction of liquid
13: gas phase portion containing generated gas
20: bremsstrahlung radiation generating target (radiation generation unit)
21: electron beam
22: bremsstrahlung radiation
30: separation device (separation unit)
40: pump
41: heater
42: cooler
50: metal member
60: gas chamber

1. A radionuclide production system for producing a radionuclide by irradiating a liquid containing a raw material nuclide with bremsstrahlung radiation, the radionuclide production system comprising:
a circulation path configured to allow a liquid containing a raw material nuclide to circulate; and
a radiation generation unit configured to generate bremsstrahlung radiation to irradiate the liquid, wherein
a metal member containing a pure metal of a platinum group or an alloy of the platinum group is provided at an upper portion in the circulation path.

2. The radionuclide production system according to claim 1, wherein
the raw material nuclide is radium 226 (Ra-226).

3. The radionuclide production system according to claim 1, wherein
the liquid is a liquid containing no halogen molecule, halogen compound, or halogen ion.

4. The radionuclide production system according to claim 1, wherein
the metal member is a thin wire, a mesh, or a structural member that forms the circulation path having a fine groove or a fine hole in a surface of the structural member.

5. The radionuclide production system according to claim 1, wherein
the radiation generation unit is a bremsstrahlung radiation generating target to be irradiated with an electron beam to generate the bremsstrahlung radiation, and
the electron beam and the bremsstrahlung radiation enter the liquid from a lateral side of the circulation path.

6. The radionuclide production system according to claim 1, wherein
the radiation generation unit is a bremsstrahlung radiation generating target to be irradiated with an electron beam to generate the bremsstrahlung radiation, and
the electron beam and the bremsstrahlung radiation enter the liquid from above or below the circulation path.

7. The radionuclide production system according to claim 1, wherein
the radiation generation unit is provided in proximity to a structural member forming the circulation path or provided integrally with a structural member forming the circulation path.

8. The radionuclide production system according to claim 1, wherein
the metal member at the upper portion in the circulation path functions as the radiation generation unit to generate the bremsstrahlung radiation.

9. The radionuclide production system according to claim 1, further comprising:
on the circulation path, a pump for circulating the liquid.

10. The radionuclide production system according to claim 1, further comprising:
on the circulation path, a separation unit configured to separate, from the raw material nuclide, a radionuclide generated by irradiation performed with the bremsstrahlung radiation.

11. The radionuclide production system according to claim 1, wherein
the circulation path is configured such that the liquid is circulated in a vertical direction.

12. The radionuclide production system according to claim 1, wherein
the circulation path is configured such that the liquid is circulated in a horizontal direction.

13. The radionuclide production system according to claim 1, wherein
a gas chamber configured to allow a gas to be retained is provided at the upper portion in the circulation path, and
the metal member is provided in the gas chamber.

14. The radionuclide production system according to claim 1, further comprising:
a heater configured to heat the liquid in the circulation path; and
a cooler configured to cool the liquid in the circulation path, wherein
the heater is disposed at a lower portion of the circulation path, and
the cooler is disposed on an upper portion of the circulation path.

15. A radionuclide production method of producing a radionuclide by irradiating a liquid containing a raw material nuclide with bremsstrahlung radiation, the radionuclide production method comprising:
transforming a raw material nuclide contained in a liquid to a radionuclide by irradiating the liquid containing the raw material nuclide with bremsstrahlung radiation while circulating the liquid in a circulation path; and
removing oxygen and hydrogen generated due to radiolysis of the liquid by a recombination reaction with a metal member formed of a pure metal of a platinum group or an alloy of the platinum group at an upper portion in the circulation path.
